(19) United States
(12) Patent Application Publication
(10) Pub. No.: US 2012/0057575 A1
(43) Pub. Date: Mar. 8, 2012

(54) METHOD AND APPARATUS FOR SIMULTANEOUS BEAM TRAINING

(75) Inventors: Mohammad Hossein Taghavi Nasrabadi, San Diego, CA (US); Avinash Jain, San Diego, CA (US); Hemanth Sampath, San Diego, CA (US)

(73) Assignee: QUALCOMM Incorporated, San Diego, CA (US)

(21) Appl. No.: 13/038,496

(22) Filed: Mar. 2, 2011

Related U.S. Application Data
(60) Provisional application No. 61/314,420, filed on Mar. 16, 2010.

(51) Int. Cl. H04W 4/00

(52) U.S. Cl. 370/338

(57) ABSTRACT

Certain aspects of the present disclosure support techniques for simultaneous beam training of multiple pairs of wireless nodes for reduction of training overhead. Each pair of wireless nodes can utilize a different training sequence in order to mitigate interference. In one aspect, different training sequences can be based on different Golay codes with appropriate correlation properties.

### CLAIM OF PRIORITY UNDER 35 U.S.C. §119

The present application for patent claims benefit of U.S. Provisional Patent Application Ser. No. 61/314,420, entitled, “SIMULTANEOUS BEAM TRAINING,” filed Mar. 16, 2010, and assigned to the assignee hereof and hereby expressly incorporated by reference herein.

### BACKGROUND

1. Field

Certain aspects of the present disclosure generally relate to wireless communications and, more particularly, to simultaneous beam training of multiple pairs of wireless nodes.

2. Background

In order to address the issue of increasing bandwidth requirements that are demanded for wireless communications systems, different technologies are being developed to allow multiple wireless nodes to communicate by sharing the channel resources while achieving high data throughputs. These technologies have been adopted in several emerging wireless communications standards, such as the family of Institute of Electrical Engineers (IEEE) 802.11 wireless communication standards and the family of IEEE 802.15 wireless communication standards.

The IEEE 802.11 denotes a set of Wireless Local Area Network (WLAN) air interface standards developed by the IEEE 802.11 committee for short-range communications (e.g., tens of meters to a few hundred meters). One example includes IEEE 802.11ad to support 60 GHz operation, which is sometimes referred as “Extremely High Throughput.”

Another example protocol for high throughput systems includes the IEEE 802.15.3c Media Access Control (MAC) protocol for wireless personal area networks (PAN). The 802.15.3c MAC protocol provides dedicated time-intervals for each pair of wireless nodes in a communications system to train with respect to each other, prior to data communication. However, as the number of peer-to-peer communications grows, this mechanism suffers from increased training overhead.

### SUMMARY

Certain aspects of the present disclosure provide a method for wireless communications. The method generally includes selecting, by a first apparatus, a training sequence from a plurality of training sequences to perform beam training with a second apparatus simultaneously with beam training of at least one other pair of apparatuses, and performing the beam-training with the second apparatus using the selected training sequence simultaneously with the beam training of the other pair of apparatuses.

Certain aspects of the present disclosure provide an apparatus for wireless communications. The apparatus generally includes a first circuit configured to select a training sequence from a plurality of training sequences to perform beam training with another apparatus simultaneously with beam training of at least one other pair of apparatuses, and a second circuit configured to perform the beam training with the other apparatus using the selected training sequence simultaneously with the beam training of the other pair of apparatuses.

Certain aspects of the present disclosure provide an apparatus for wireless communications. The apparatus generally includes means for selecting a training sequence from a plurality of training sequences to perform beam training with another apparatus simultaneously with beam training of at least one other pair of apparatuses, and means for performing the beam training with the other apparatus using the selected training sequence simultaneously with the beam training of the other pair of apparatuses.

Certain aspects provide a computer-program product for wireless communications. The computer-program product includes a computer-readable medium comprising instructions executable to select, by a first apparatus, a training sequence from a plurality of training sequences to perform beam training with a second apparatus simultaneously with beam training of at least one other pair of apparatuses, and perform the beam training with the second apparatus using the selected training sequence simultaneously with the beam training of the other pair of apparatuses.

Certain aspects of the present disclosure provide a wireless node. The wireless node generally includes at least one antenna, a first circuit configured to select a training sequence from a plurality of training sequences to perform beam training with another wireless node simultaneously with beam training of at least one other pair of wireless nodes, a second circuit configured to perform the beam training with the other wireless node using the selected training sequence simultaneously with the beam training of the other pair of wireless nodes, and a transmitter configured to transmit via the at least one antenna a plurality of signals constructed based on the selected training sequence.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a conceptual block diagram illustrating the hardware configuration for an exemplary apparatus in accordance with certain aspects of the present disclosure.

FIG. 2 is a flow diagram illustrating an example of a timeline for peer-to-peer training in accordance with certain aspects of the present disclosure.

FIG. 3 is a conceptual block diagram illustrating the functionality of an exemplary apparatus in accordance with certain aspects of the present disclosure.

FIGS. 4A-4B illustrate an example of four pairs of stations (STAs) communicating and training overhead results in accordance with certain aspects of the present disclosure.

FIGS. 5A-5B illustrate examples of correlation properties of proposed training sequences in accordance with certain aspects of the present disclosure.

FIGS. 6A-6B illustrate an example of simultaneous training of two pairs of STAs and training overhead results in accordance with certain aspects of the present disclosure.

FIGS. 7A-7B illustrate an example of simultaneous training of three pairs of STAs and training overhead results in accordance with certain aspects of the present disclosure.

FIG. 8 illustrates an example sector-level beam training of a pair of STAs in accordance with certain aspects of the present disclosure.

FIG. 9 illustrates an example of simultaneous time-aligned beam training of two pairs of STAs in accordance with certain aspects of the present disclosure.

FIG. 10 illustrates an example of simultaneous non-aligned beam training of two pairs of STAs in accordance with certain aspects of the present disclosure.

FIG. 11 illustrates example operations for performing beam-training in accordance with certain aspects of the present disclosure.

FIG. 11A illustrates example components capable of performing the operations illustrated in FIG. 11.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different wireless technologies, system configurations, networks and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Several aspects of a wireless communications system will now be presented. The wireless communications system may support any number of apparatuses. In this example, each apparatus is implemented as a wireless node. A wireless node may be a station (STA), or other suitable node.

### An Example Wireless Communication System

The wireless communications system may be configured to support multiple STAs employingMultiple-Input and Multiple-Output (MIMO) technology supporting any suitable wireless technology, such as Orthogonal Frequency Division Multiplexing (OFDM). An OFDM system may implement IEEE 802.11, IEEE 802.15, or some other air interface standard. Other suitable wireless technologies include, by way of example, Code Division Multiple Access (CDMA), Time Division Multiple Access (TDMA), or any other suitable wireless technology, or any combination of suitable wireless technologies. A CDMA system may implement IS-2000, IS-95, IS-856, Wideband-CDMA (WCDMA), or some other suitable air interface standard. A TDMA system may implement Global System for Mobile Communications (GSM) or some other suitable air interface standard. As those skilled in the art will readily appreciate, the various aspects of this disclosure are not limited to any particular wireless technology and/or air interface standard. The various concepts presented throughout this disclosure may also be extended to short range radio technology, such as Ultra-Wide Band (UWB), or some other short range air interface standard such as Bluetooth. The actual wireless technology and air interface standard employed for any particular communications system will depend on the specific application and the overall design constraints imposed on the system. The various concepts presented throughout this disclosure are equally applicable to a wireless communications system employing other wireless technologies and/or air interface standards.

The wireless communications system may support any number of APs distributed throughout a geographic region. A STA, which may be fixed or mobile, may engage in peer-to-peer communications with other STAs. Examples of STAs include a mobile telephone, laptop computer, a personal digital assistant (PDA), a mobile digital audio player, a mobile game console, a digital camera, a digital camcorder, a mobile audio device, a mobile video device, a mobile multimedia device, a smart phone, a tablet, a television display, a flip-cam, a security video camera, a digital video recorder (DVR), a set top box kiosk, or a media center, or any other suitable device capable of supporting wireless communications. A STA may utilize the backhaul services of an access point (AP) to gain access to a larger network (e.g., Internet). According to aspects of the present disclosure, a STA may operate in accordance with the IEEE 802.11 interface standard, or alternatively in accordance with the IEEE 802.15 interface standard.

A STA may be referred to by those skilled in the art by different nomenclature. By way of example, a STA may be referred to as a user terminal, a mobile station, a subscriber station, a wireless device, a terminal, an access terminal, a node, or some other suitable terminology. The various concepts described throughout this disclosure are intended to apply to all suitable apparatuses regardless of their specific nomenclature.

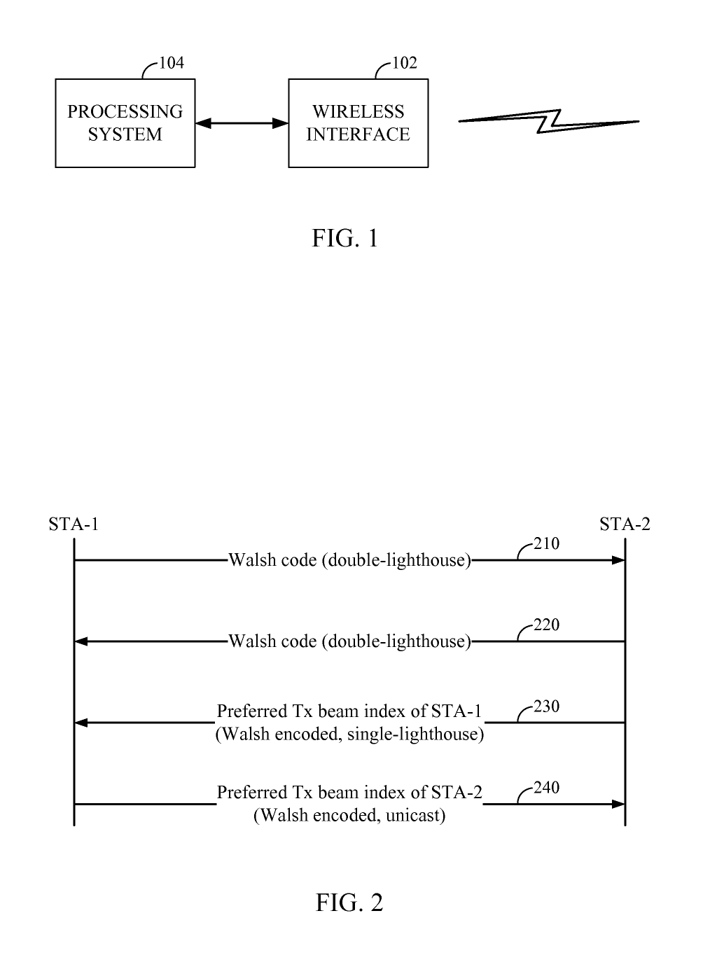

Various aspects of an apparatus will now be presented with reference to FIG. 1. FIG. 1 is a conceptual block diagram illustrating a hardware configuration for an apparatus. The apparatus 100 may comprise a wireless interface 102 and a processing system 104.

The wireless interface 102 may comprise a transceiver having a transmitter and receiver function to support two-way communications over the wireless medium. Alternatively, the wireless interface 102 may be configured as a transmitter or receiver to support one-way communications. In the detailed description that follows, a wireless interface may be described as a transmitter or a receiver to illustrate a particular aspect of the invention. Such a reference does not imply that the wireless interface is incapable of performing both transmit and receive operations.

The wireless interface 102 may support different air interface protocols. By way of example, the wireless interface 102 may comprise a 60 GHz radio to support IEEE 802.11 ad (Extremely High Throughput), or some other suitable air interface protocol. The wireless interface 102 may also be configured to implement the physical layer by modulating wireless signals and performing other radio frequency (RF) front end processing. Alternatively, the physical layer processing function may be performed by the processing system 104.

The wireless interface 102 is shown as a separate entity. However, as those skilled in the art will readily appreciate, the wireless interface 102, or any portion thereof, may be integrated into the processing system 104, or distributed across multiple entities within the apparatus 100.

The processing system 104 may be implemented with one or more processors. The one or more processors may be implemented with any combination of general-purpose microprocessors, microcontrollers, a Digital Signal Processors (DSP), Field Programmable Gate Arrays (FPGA), Programmable Logic Devices (PLD), controllers, state machines, gated logic, discrete hardware components, or any other suitable entities that can perform calculations or other manipulations of information.

The processing system 104 may also comprise machine-readable media for storing software. Software shall be construed broadly to mean any type of instructions, whether referred to as software, firmware, middleware, microcode, hardware description language, or otherwise. Instructions may comprise code (e.g., in source code format, binary code format, executable code format, or any other suitable format of code). The instructions, when executed by the one or more processors, may cause the processing system 104 to perform the various functions described below, as well as other protocol processing functions (e.g., data link layer processing).

Machine-readable media may comprise storage integrated into one or more of the processors. Machine-readable media may also comprise storage external to the one or more processor, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. In addition, machine-readable media may comprise a transmission line or a carrier wave that encodes a data signal. Those skilled in the art will recognize how best to implement the described functionality for the processing system.

### Multiple Peer-to-Peer Signaling

FIG. 2 is a flow diagram illustrating an example of a timeline for peer-to-peer training for multiple STAs. Each STA may comprise a processing system 104 and a wireless interface 102. The AP may reserve a dedicated time-interval for peer-to-peer training. The AP may transmit to each STA a trainingSequenceID using unicast downlink (DL) control frame message. Using the trainingSequenceID, multiple pairs of STAs may perform peer-to-peer training simultaneously. A pair of STAs STA-1 and STA-2 may perform peer-to-peer training as follows.

First, the STA-1 may transmit a Walsh or a Golay sequence (trainingSequenceID) of length L serially across A_{T} transmit beam patterns (e.g., directions) supported by the STA-2, N_{R} times for each transmit beam pattern, where N_{R} is the number of receive beam patterns supported by the STA-2 (step 210). Such a transmission can be referred to as a “double-lighthouse” transmission. Assuming A_{T} and N_{R} are each 64, a system chip-rate of 1.7 Gps, a Walsh/Golay chip duration of 0.6 ns, and L=64, the total transmission time may be approximately 157 us (0.6 ns*64*64*64).

The training may be performed during a service period (i.e., allocation period) assigned by another wireless node. The service/allocation period may be a dedicated period of time assigned by another wireless node for one or more pairs of wireless terminals to perform training. In one configuration, the training may be performed using a code sequence selected from a set of code sequences that are also being used by one or more other pairs to perform training. That is, the STA-1 may select a code sequence from a set of code sequences. The set of code sequences may be also used by other pairs to perform training The selection may be random or predetermined through an algorithm. In another configuration, the training may be performed using a code sequence assigned by another wireless node (e.g., AP). In such a configuration, the code sequence may not be used by the one or more other pairs to perform training. That is, the code sequence transmitted by the STA-1 may be selected by another wireless node, such as an access point, and that code sequence may not be used by other pairs to perform training. As discussed supra, the code sequence may be a Walsh sequence or a Golay sequence.

For 60 GHz short-range PAN type networks, typically there are not more than 16 active stations per AP. As such, at any given peer-to-peer training time, no more than eight pairs of STAs may engage in peer-to-peer training.

The STA-2 may receive the sequence from the STA-1 and estimate preferred (e.g., the best) transmit and receive beam patterns for STA-1 to STA-2 communication based on Walsh/Golay correlation of the received waveform using the trainingSequenceID. As such, after step 210, the STA-2 may know the preferred transmit and receive beam patterns for the STA-1 to STA-2 communication.

Second, the STA-2 may transmit a Walsh or a Golay sequence (specified by trainingSequenceID) serially across N_{T} transmit beam patterns supported by the STA-2, A_{R} times for each beam pattern (double-lighthouse), where A_{R} is the number of receive beam patterns supported by the STA-1 (step 220). Assuming N_{T} and A_{R} are each 64, a system chip-rate of 1.7 Gps, a Walsh/Golay chip duration of 0.6 ns, and L=64, the total transmission time may be approximately 157 us (0.6 ns*64*64*64).

The STA-1 may receive the sequence from the STA-2 and estimate preferred transmit and receive beam patterns for STA-2 to STA-1 communication based on Walsh/Golay correlation of the received waveform using the trainingSequenceID. As such, after step 220, the STA-1 may know the preferred transmit and receive beam patterns for the STA-2 to STA-1 communication.

Third, the STA-2 may then transmit a sequence corresponding to a 6-bit transmit beam index to the STA-1 (step 230). The index may indicate a preferred transmit beam pattern for STA-1 to STA-2 communication (i.e., one of the A_{T} transmit beam patterns). The STA-2 may select a length L Walsh or Golay sequence corresponding to the 6-bit index. The STA-2 may scramble the length L sequence with a seed equal to the trainingSequenceID. In an aspect, the scrambling sequence generator may be in accordance with the IEEE 802.15.3c specification. The STA-2 may transmit this sequence serially across N_{T} transmit beam patterns, only once for each transmit beam pattern. Because the STA-1 may know the preferred receive beam pattern for STA-2 to STA-1 communication (i.e., one of the A_{R} receive beam patterns), the STA-1 may use its preferred receive beam pattern to receive the sequence. This transmission can be referred to as a “single-lighthouse” transmission. Assuming L is 256, the total transmission time may be approximately 10 us (0.6 ns*256*64). As such, after step 230, the STA-1 may know the preferred transmit and receive beam patterns for STA-2 to STA-1 communication and the preferred transmit beam pattern for STA-1 to STA-2 communication.

Fourth, the STA-1 may transmit a sequence corresponding to a 6-bit transmit beam index to the STA-2 (step 240). The index may indicate a preferred transmit beam pattern for STA-2 to STA-1 communication (i.e., one of the N_{T} transmit beam patterns). The STA-1 may select a length L Walsh or Golay sequence corresponding to the 6-bit index. The STA-1 may scramble the length L sequence with a seed equal to the trainingSequenceID. In an aspect, the scrambling sequence generator may be in accordance with the 802.15.3c specification. The STA-1 may transmit the sequence through the preferred transmit beam pattern for STA-1 to STA-2 communication (i.e., one of the A_{T} transmit beam patterns). Because the STA-2 may know the preferred receive beam pattern for STA-1 to STA-2 communication, the STA-2 may use its preferred receive beam pattern (i.e., one of the N_{R} receive beam patterns) to receive the sequence. Assuming L equals 256, the total transmission time may be approximately 150 ns (0.6 ns*256).

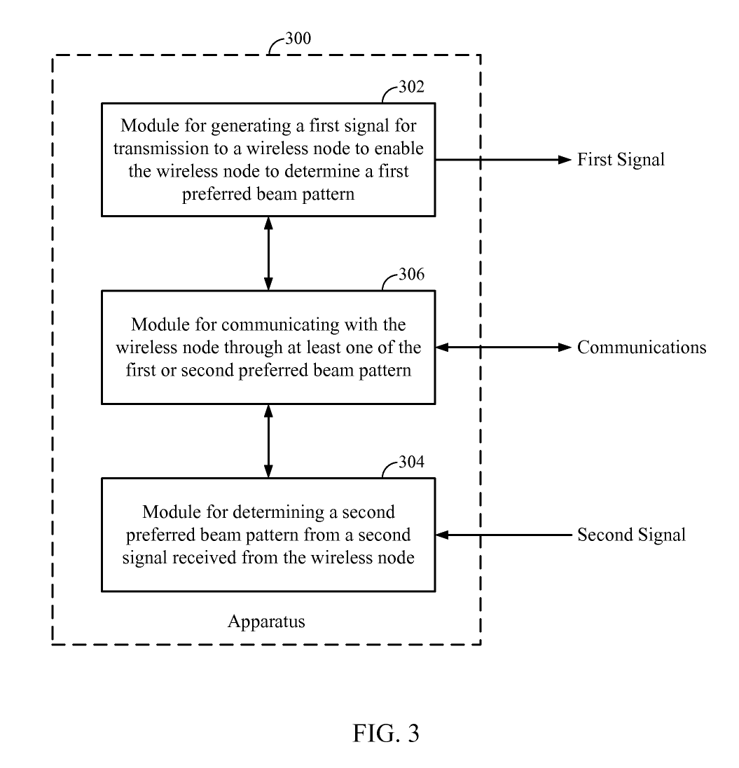

FIG. 3 is a conceptual block diagram illustrating the functionality of an exemplary apparatus 300. The apparatus 300 may comprise a module 302 for generating a first signal for transmission to a wireless node to enable the wireless node to determine a first preferred beam pattern, a module 304 for determining a second preferred beam pattern from a second signal received from the wireless node, a module 306 for communicating with the wireless node through at least one of the first or second preferred beam pattern. In one configuration, the apparatus 300 may comprise a processing system 104, and the processing system 104 may be configured to perform the functions of each of the modules 302-306. In one configuration, the first preferred beam pattern may comprise a preferred transmit beam pattern supported by the apparatus 300 and a preferred receive beam pattern supported by the wireless node; and the second preferred beam pattern may comprise a preferred transmit beam pattern supported by the wireless node and a preferred receive beam pattern supported by the apparatus 300. In one configuration, the apparatus 300 may be configured to receive a third signal from the wireless node and to send a fourth signal to the wireless node. The third signal corresponds to the first preferred beam pattern and may correspond to the preferred transmit beam pattern supported by the apparatus. The fourth signal corresponds to the second preferred beam pattern and may correspond to the preferred transmit beam pattern supported by the wireless node. In another configuration, the apparatus 300 may be configured to transmit a third signal to the wireless node and to receive a fourth signal from the wireless node. The third signal corresponds to the second preferred beam pattern and may correspond to the preferred transmit beam pattern supported by the wireless node. The fourth signal corresponds to the first preferred beam pattern and may correspond to the preferred transmit beam pattern supported by the apparatus.

In one configuration, the apparatus 300 may comprise means for generating a first signal for transmission to a wireless node to enable the wireless node to determine a first preferred beam pattern; means for determining a second preferred beam pattern from a second signal received from the wireless node; and means for communicating with the wireless node through at least one of the first or second preferred beam pattern. The aforementioned means is the processing system 104 configured to perform the functions of the aforementioned means.

According to certain aspects, periodic beam training may be required to achieve multi-Gbps throughput in 60 GHz transmission band (i.e., for IEEE 802.11ad interface protocol, referred also as “Extremely High Throughput” protocol) to account for blockage, movement, change of orientation, and so on. Typically, STAs may utilize dedicated service (time) periods to beam-train in order to prevent disruption to other 60 GHz traffic. The resulting beam training overhead may be significant for 60 GHz network with multiple STAs, e.g., for a network of eight STAs in a conference room. Methods and apparatus are proposed in the present disclosure to reduce this beam-training overhead.

### Simultaneous Beam Training of Multiple Pairs of Stations

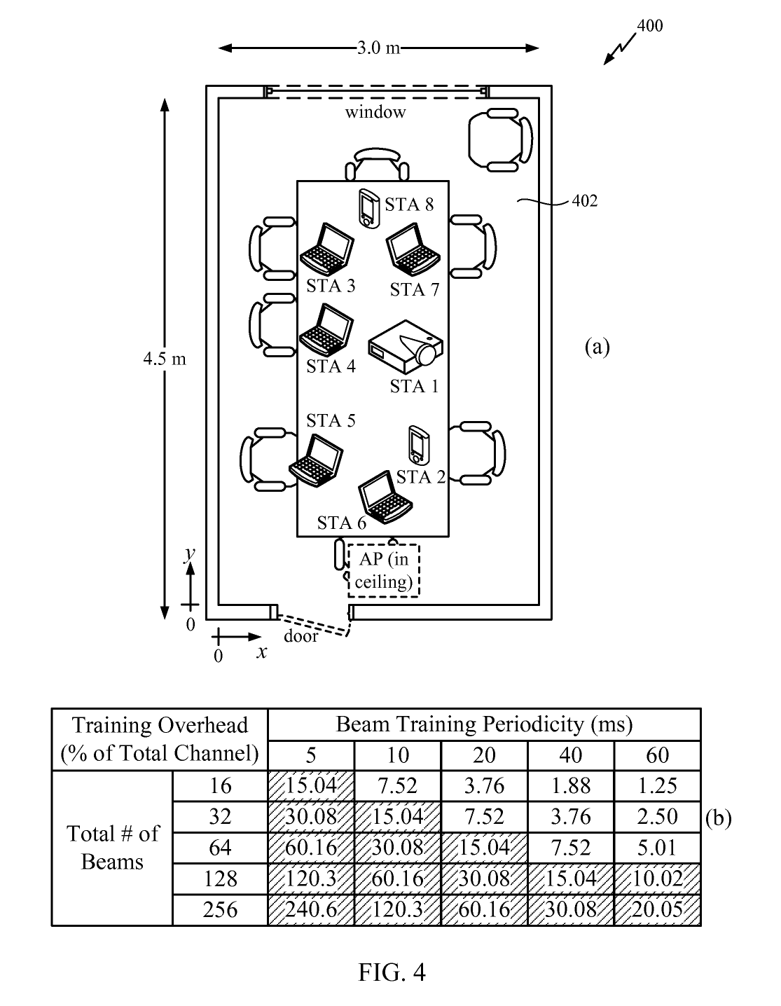

FIG. 4A illustrates an example 400 of four pairs of peers or stations (STAs) communicating in a conference room setup 402 in accordance with certain aspects of the present disclosure. In an aspect, beam training between pairs of STAs may be performed by utilizing IEEE 802.15.3c based long preamble with duration of 4.7 μs. The beam training by four pairs of STAs using separate dedicated time slots may lead to a significant training overhead, as illustrated in FIG. 4B. This overhead may significantly reduce a perceived network throughput.

In order to reduce the training overhead, multiple pairs of STAs may be allowed to perform beam training simultaneously. Each pair of STAs may utilize a different training sequence in order to mitigate interference. In an aspect, the different training sequences may be based on different Golay codes, where multiple Golay codes with good cross-correlation properties may be generated using the same hardware.

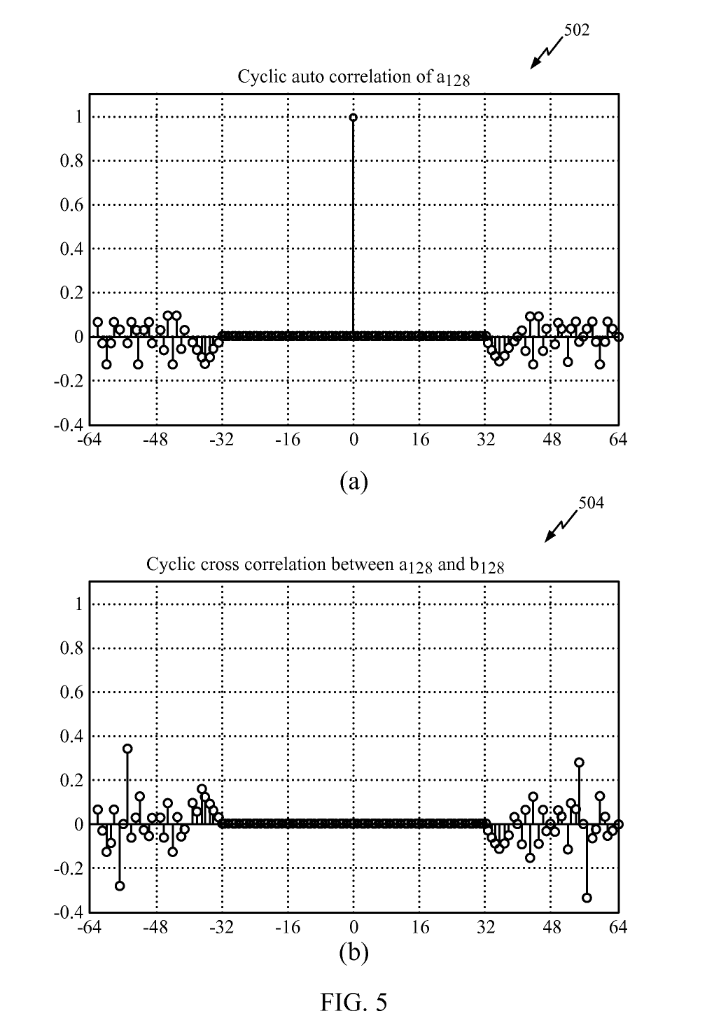

FIGS. 5A-5B illustrate examples of correlation properties of two complementary Golay sequences a₁₂₈ and b₁₂₈ of length 128 that may be in accordance with the IEEE 802.15.3c interface protocol. FIG. 5A illustrates an example 502 of cyclic auto correlation of the Golay code a₁₂₈, and FIG. 5B illustrates an example 504 of cyclic cross correlation between the codes a₁₂₈ and b₁₂₈. It can be observed from FIGS. 5A-5B good correlation properties of the codes a₁₂₈ and b₁₂₈.

In an aspect, the cyclic cross-correlation 504 illustrated in FIG. 5B may represent a normalized cyclic cross-correlation. The cyclic cross-correlation of two sequences, each sequence comprising +1 and −1 values with a certain relative cyclic delay, may be first computed and then this cross-correlation result may be divided by the length of code (128 in this case) in order to obtain a normalized cyclic cross-correlation. Moreover, the cyclic auto correlation 502 illustrated in FIG. 5A may represent a normalized cyclic auto correlation.

Aspects of the present disclosure confirm that simultaneous training of two pairs of devices may reduce the beam-training overhead by approximately 50%. Performances of simultaneous beam training of two and three pairs of STAs are provided in following paragraphs of the detailed description.

In an aspect of the present disclosure, channels can be generated using the TGad (Task Group ad) Conference Room channel model. A training sequence can be transmitted across each of transmission beams in a random order. For example, there can be 19 transmission beams of 60° half power bandwidth (HPBW) covering the half space for z>0. The training sequence may be received in an omni-directional mode (covering z>0) and using a simple correlator detector. The receiver may select a preferred transmission beam by comparing the strength of the received training sequences across all beam directions. A random delay of 0-20 chips can be added to model in-room propagation delays. In an exemplary case, performance results are averaged over 100 channel realizations and 10 noise realizations with beam-ordering per channel realization.

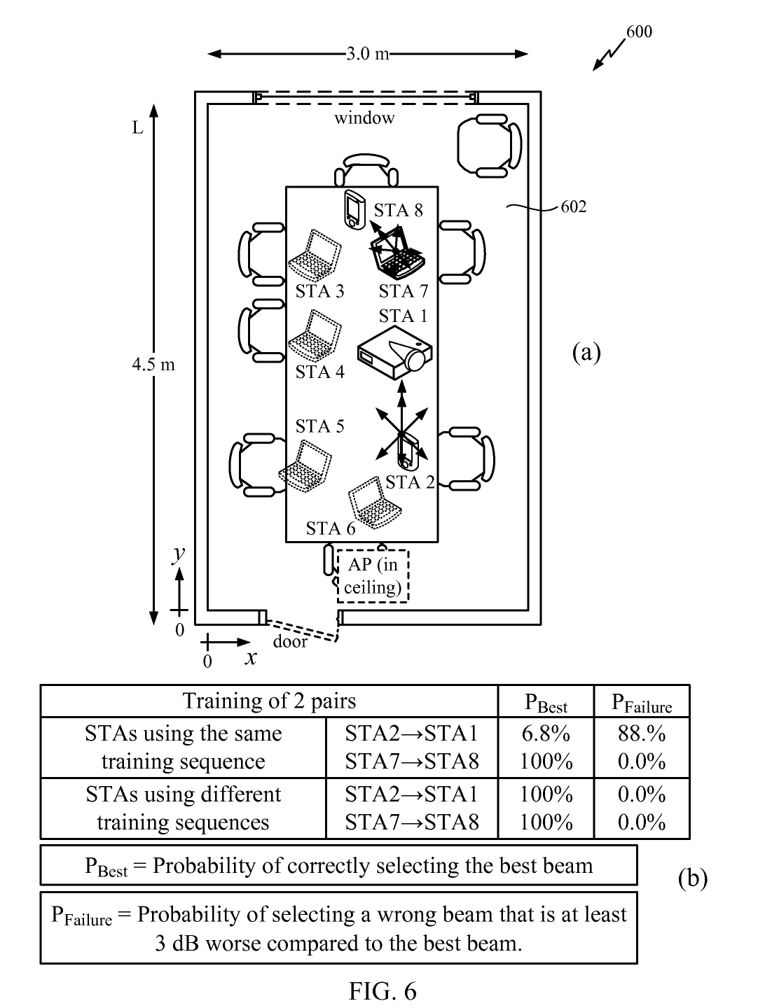

FIG. 6A illustrates an example 600 of simultaneous training of two pairs of STAs in a conference room setup 602 in accordance with certain aspects of the present disclosure. The STA2→STA1 beam training may utilize the Golay code a₁₂₈ that may be in accordance with the IEEE 802.15.3c interface protocol. The STAT STA8 beam training may utilize the Golay code b₁₂₈ that may be in accordance with the IEEE 802.15.3c interface protocol. To illustrate benefit of interference suppression using distinct Golay codes, performance can be compared to the case where every STA utilizes the code a₁₂₈ as the training sequence. It can be observed from FIG. 6B that 50% reduction of training overhead may be achieved with no performance degradation when using distinct Golay codes, where P_{Best} represents a probability of correctly selecting a preferred (best) beam, and P_{Failure} represents a probability of selecting a wrong beam that provides at least 3 dB worse performance compared to the preferred (best) beam.

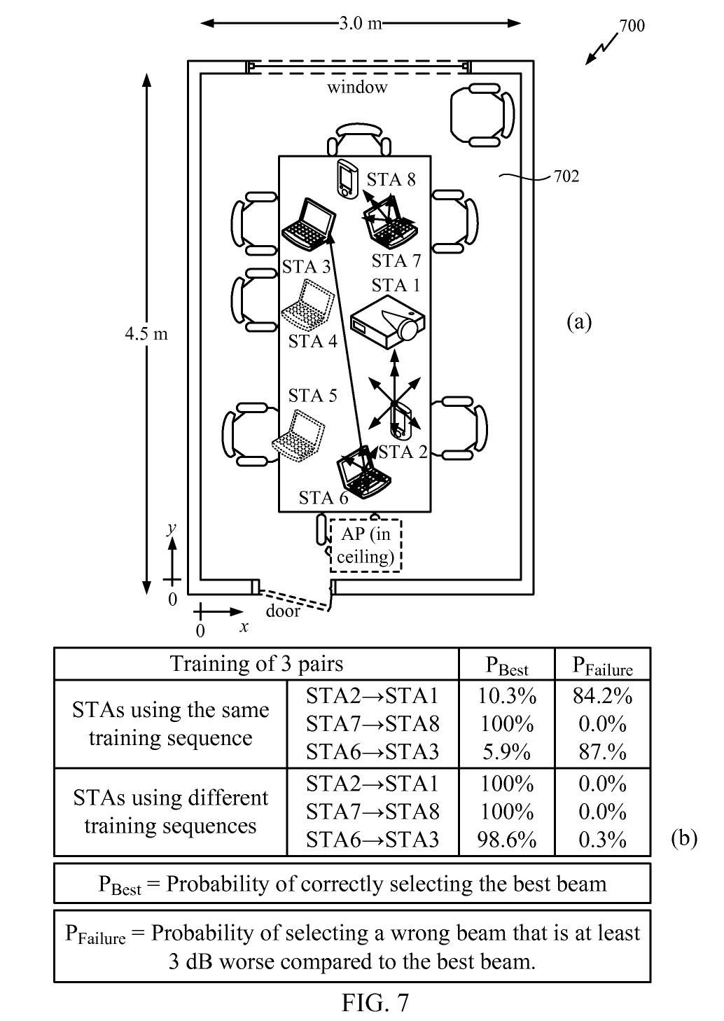

FIG. 7A illustrates an example 700 of simultaneous training of three pairs of STAs in a conference room setup 702 in accordance with certain aspects of the present disclosure. The STA2→STA1 and STA7→STA8 beam trainings may utilize the Golay codes a₁₂₈ and b₁₂₈, respectively. The third pair STA6→STA3 beam training may use concatenation of Golay codes a₆₄ and b₆₄ that may be in accordance with the IEEE 802.15.3c interface protocol. It can be observed from FIG. 7B that 67% reduction of training overhead may be achieved with minimal performance degradation when using distinct Golay codes, where P_{Best} represents a probability of correctly selecting a preferred (best) beam, and P_{Failure} represents a probability of selecting a wrong beam that provides at least 3 dB worse performance compared to the preferred (best) beam.

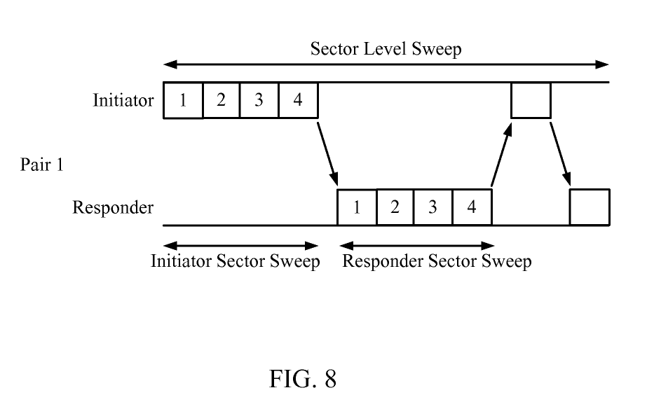

Certain aspects of the present disclosure support simultaneous beam training of multiple pairs of STAs configured to operate according to the IEEE 802.11ad interface protocol. The simultaneous beam training may be overlaid on any beam training protocol with transmit/receive sweep. As illustrated in FIG. 8, the sector level beam training can be considered with an initiator sector sweep and a responder sector sweep. In an aspect, an access point may assign the same service period to multiple pairs of STAs for beam training During training, each pair of STA may utilize a different Golay code in the training preamble, channel estimation sequence (CES) and payload. Therefore, two or more Golay codes may need to be designed with desirable correlation properties.

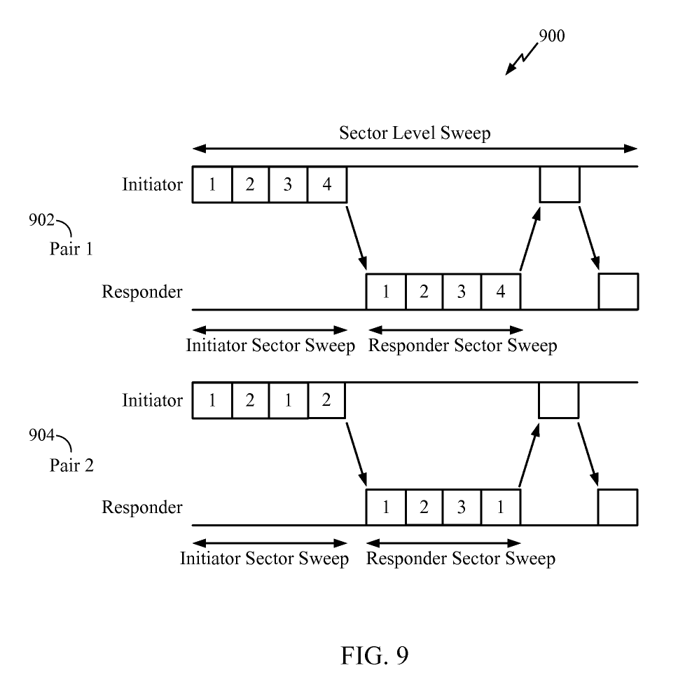

In one aspect of the present disclosure, STAs may be configured to align transmit/receive sector sweeps during beam training FIG. 9 illustrates an example 900 of simultaneous time-aligned beam training of two pairs of STAs (i.e., pairs 902 and 904) in accordance with certain aspects of the present disclosure. In an aspect, a coarse time-alignment may be sufficient, i.e., no chip-level synchronization across STAs may be required. For two pairs of STAs performing simultaneous beam training, complementary Golay codes with zero cross-correlation zone of ±32 chips may be utilized. This particular zero cross-correlation zone may be sufficient to account for in-room round-trip delays and timing errors. For more than two pairs of STAs performing simultaneous beam training, the length of zero cross-correlation zone may be reduced. As illustrated in FIG. 9, the pair of STAs 904 that finishes earlier each phase of training (i.e., transmit or receive phase) may continue to physically or virtually sweep their beams.

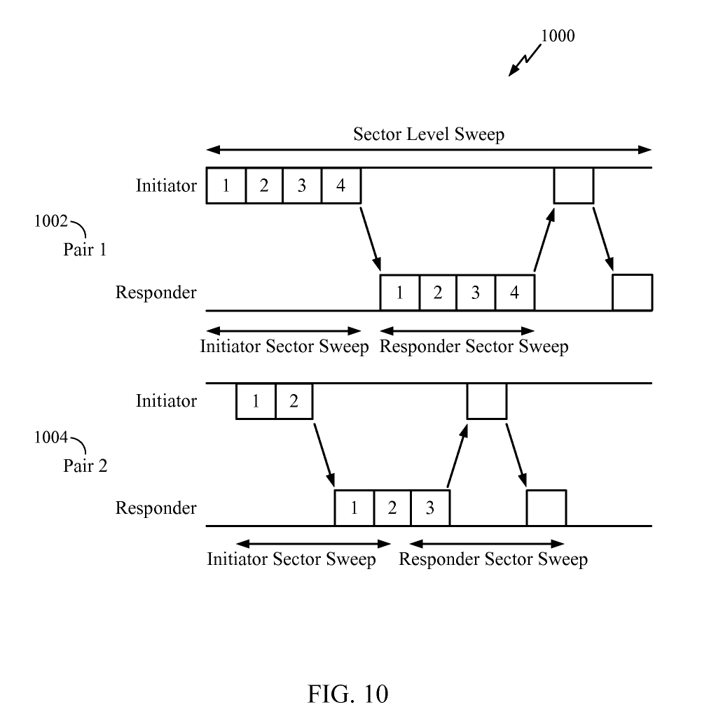

In another aspect of the present disclosure, STAs may not be required to align their transmit/receive sector sweeps during the beam training process. This approach may be applied, for example, for the Wireless Gigabit Alliance (WGA) interface protocol. FIG. 10 illustrates an example 1000 of simultaneous non-aligned beam training of two pairs of STAs (i.e., pairs 1002 and 1004) in accordance with certain aspects of the present disclosure. For two pairs of STAs performing non-aligned simultaneous beam-training, complementary Golay codes may be utilized that provide, for example, approximately 18 dB of interference suppression without time alignment. It should be noted that these Golay codes may be different from Golay codes utilized for beam training with time-alignment. For up to four pairs of STA that perform simultaneous beam-training, Golay codes providing approximately 15 dB of interference suppression without time alignment may be utilized, for example. As illustrated in FIG. 10, the pair of devices 1004 with fewer number of beam/sector directions may be allowed to finish its training earlier.

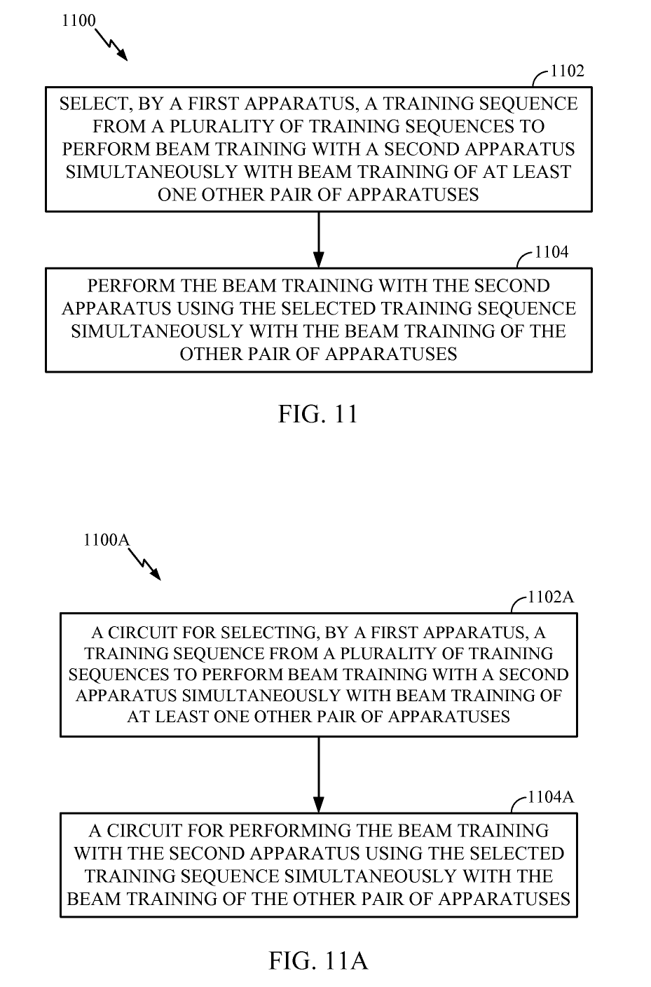

FIG. 11 illustrates example operations 1100 for performing beam training between a pair of STAs in accordance with certain aspects of the present disclosure. The operations 1100 may be performed at a wireless node (a STA) of a wireless communications system. At 1102, a STA-1 may select a training sequence from a plurality of training sequences in order to perform beam training with a STA-2 simultaneously with beam training of at least one other pair of STAs. At 1104, the STA-1 may perform the beam training with the STA-2 using the selected training sequence simultaneously with the beam training of the other pair of STAs.

In an aspect of the present disclosure, selection of the training sequence may be based on an index of the training sequence assigned by an access point of the wireless communications system. In another aspect, the selection may be based on STA identification. In yet another aspect, the selection may be based on a network identifier. Further, the training sequence may be selected randomly from the plurality of training sequences. Finally, the training sequence may be selected based on an assigned priority relative to other STAs in the wireless communications system. The priority may be identified as a flag in an assignment message transmitted from the access point.

In an aspect of the present disclosure, the beam training may comprise transmitting a plurality of signals constructed based on the selected training sequence. The transmission of the plurality of signals may be performed in a predetermined period that may be specified by another STA or the access point. This predetermined period may comprise a plurality of slots, and, in the case of time-aligned simultaneous beam-training illustrated in FIG. 9, each of the signals may be transmitted within a slot of the plurality of slots starting at a beginning of the slot. As illustrated in FIG. 9, a signal from the plurality of signals may be transmitted multiple times along a beam direction, if the number of slots is greater than the number of signals in the plurality of signals.

For supporting the time-aligned beam training, the plurality of training sequences may be designed such that a zero cross-correlation zone associated with the training sequences may be greater than or equal to a defined number of chip periods. In one aspect, the zero cross-correlation zone may be equal to at least one quarter of a length of the training sequence. In another aspect, a zero cross-correlation zone of a pair of training sequences from the plurality of training sequences may be equal to a quarter of the length of training sequence.

In order to support the non-aligned beam training illustrated in FIG. 10, the plurality of training sequences may be designed such that a magnitude of normalized cyclic cross-correlation between any pair of training sequences from the plurality of training sequences may not be greater than a tolerance value. In one aspect, the tolerance value may be less than or equal to 0.25. In another aspect, the tolerance value may be equal to 0.125 times a length of the training sequence. In yet another aspect, the tolerance value may be equal to 0.1875 times the length of training sequence, wherein the plurality of training sequences may comprise at least four training sequences.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, operations 1100 illustrated in FIG. 11 correspond to components 1100A illustrated in FIG. 11A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

For example, the means for selecting may comprise an application specific integrated circuit, e.g., the processing system 104 from FIG. 1. The means for performing beam training may comprise an application specific integrated circuit, e.g., the module 302 from FIG. 3 of the apparatus 300, the module 304 from FIG. 3 of the apparatus 300, or the module 306 from FIG. 3 of the apparatus 300. The means for transmitting may comprise a transmitter, e.g., the module 306 depicted in FIG. 3.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. A method for wireless communications, comprising:
selecting, by a first apparatus, a training sequence from a plurality of training sequences to perform beam training with a second apparatus simultaneously with beam training of at least one other pair of apparatuses; and
performing the beam training with the second apparatus using the selected training sequence simultaneously with the beam training of the other pair of apparatuses.

2. The method of claim 1, wherein the selection is based on:
an index of the training sequence assigned by another apparatus,
an identification of the first apparatus,
a network identifier, or
an assigned priority relative to other apparatuses.

3. The method of claim 2, wherein the priority is identified as a flag in an assignment message.

4. The method of claim 1, wherein the training sequence is selected randomly from the plurality of training sequences.

5. The method of claim 1, wherein performing the beam training comprises:
transmitting a plurality of signals constructed based on the selected training sequence, and
wherein the signals are transmitted in a period specified by a third apparatus.

6. The method of claim 5, wherein:
the period comprises a plurality of slots; and
each signal from the plurality of signals is transmitted within a slot of the plurality of slots starting at a beginning of the slot.

7. The method of claim 6, further comprising:
transmitting a signal from the plurality of signals multiple times along a beam direction, if the number of slots is greater than the number of signals in the plurality of signals.

8. The method of claim 1, wherein a zero cross-correlation zone associated with the training sequences is greater than or equal to a number of chip periods.

9. The method of claim 8, wherein the zero cross-correlation zone is equal to at least one quarter of a length of the training sequence.

10. The method of claim 1, wherein a zero cross-correlation zone of a pair of training sequences from the plurality of training sequences is equal to one quarter of a length of the training sequence.

11. The method of claim 1, wherein a magnitude of normalized cyclic cross-correlation between any pair of training sequences from the plurality of training sequences is not greater than a tolerance value.

12. The method of claim 11, wherein the tolerance value is less than or equal to 0.25.

13. The method of claim 11, wherein the tolerance value is less than or equal to 0.125.

14. The method of claim 11, wherein the tolerance value is less than or equal to 0.1875, if the plurality of training sequences comprise at least four training sequences.

15. An apparatus for wireless communications, comprising:
a first circuit configured to select a training sequence from a plurality of training sequences to perform beam training with another apparatus simultaneously with beam training of at least one other pair of apparatuses; and
a second circuit configured to perform the beam training with the other apparatus using the selected training sequence simultaneously with the beam training of the other pair of apparatuses.

16. The apparatus of claim 15, wherein the selection is based on:
an index of the training sequence assigned by a third apparatus,
an identification of the apparatus,
a network identifier, or
an assigned priority relative to other apparatuses.

17. The apparatus of claim 16, wherein the priority is identified as a flag in an assignment message.

18. The apparatus of claim 15, wherein the training sequence is selected randomly from the plurality of training sequences.

19. The apparatus of claim 15, wherein:
the second circuit is also configured to transmit a plurality of signals constructed based on the selected training sequence, and
the signals are transmitted in a period specified by a third apparatus.

20. The apparatus of claim 19, wherein:
the period comprises a plurality of slots; and
each signal from the plurality of signals is transmitted within a slot of the plurality of slots starting at a beginning of the slot.

21. The apparatus of claim 20, further comprising:
a transmitter configured to transmit a signal from the plurality of signals multiple times along a beam direction, if the number of slots is greater than the number of signals in the plurality of signals.

22. The apparatus of claim 15, wherein a zero cross-correlation zone associated with the training sequences is greater than or equal to a number of chip periods.

23. The apparatus of claim 22, wherein the zero cross-correlation zone is equal to at least one quarter of a length of the training sequence.

24. The apparatus of claim 15, wherein a zero cross-correlation zone of a pair of training sequences from the plurality of training sequences is equal to one quarter of a length of the training sequence.

25. The apparatus of claim 15, wherein a magnitude of normalized cyclic cross-correlation between any pair of training sequences from the plurality of training sequences is not greater than a tolerance value.

26. The apparatus of claim 25, wherein the tolerance value is less than or equal to 0.25.

27. The apparatus of claim 25, wherein the tolerance value is less than or equal to 0.125.

28. The apparatus of claim 25, wherein the tolerance value is less than or equal to 0.1875, if the plurality of training sequences comprise at least four training sequences.

29. An apparatus for wireless communications, comprising:
means for selecting a training sequence from a plurality of training sequences to perform beam training with another apparatus simultaneously with beam training of at least one other pair of apparatuses; and
means for performing the beam training with the other apparatus using the selected training sequence simultaneously with the beam training of the other pair of apparatuses.

30. The apparatus of claim 29, wherein the selection is based on:
an index of the training sequence assigned by a third apparatus,
an identification of the apparatus,
a network identifier, or
an assigned priority relative to other apparatuses.

31. The apparatus of claim 30, wherein the priority is identified as a flag in an assignment message.

32. The apparatus of claim 29, wherein the training sequence is selected randomly from the plurality of training sequences.

33. The apparatus of claim 29, wherein:
the means for performing the beam training comprises means for transmitting a plurality of signals constructed based on the selected training sequence, and
the signals are transmitted in a period specified by a third apparatus.

34. The apparatus of claim 33, wherein:
the period comprises a plurality of slots; and
each signal from the plurality of signals is transmitted within a slot of the plurality of slots starting at a beginning of the slot.

35. The apparatus of claim 34, further comprising:
means for transmitting a signal from the plurality of signals multiple times along a beam direction, if the number of slots is greater than the number of signals in the plurality of signals.

36. The apparatus of claim 29, wherein a zero cross-correlation zone associated with the training sequences is greater than or equal to a number of chip periods.

37. The apparatus of claim 36, wherein the zero cross-correlation zone is equal to at least one quarter of a length of the training sequence.

38. The apparatus of claim 29, wherein a zero cross-correlation zone of a pair of training sequences from the plurality of training sequences is equal to one quarter of a length of the training sequence.

39. The apparatus of claim 39, wherein a magnitude of normalized cyclic cross-correlation between any pair of training sequences from the plurality of training sequences is not greater than a tolerance value.

40. The apparatus of claim 39, wherein the tolerance value is less than or equal to 0.25.

41. The apparatus of claim 39, wherein the tolerance value is less than or equal to 0.125.

42. The apparatus of claim 39, wherein the tolerance value is less than or equal to 0.1875, if the plurality of training sequences comprise at least four training sequences.

43. A computer-program product for wireless communications, comprising a computer-readable medium comprising instructions executable to:
select, by a first apparatus, a training sequence from a plurality of training sequences to perform beam training with a second apparatus simultaneously with beam training of at least one other pair of apparatuses; and
perform the beam training with the second apparatus using the selected training sequence simultaneously with the beam training of the other pair of apparatuses.

44. A wireless node, comprising:
at least one antenna;
a first circuit configured to select a training sequence from a plurality of training sequences to perform beam training with another wireless node simultaneously with beam training of at least one other pair of wireless nodes;
a second circuit configured to perform the beam training with the other wireless node using the selected training sequence simultaneously with the beam training of the other pair of wireless nodes; and
a transmitter configured to transmit via the at least one antenna a plurality of signals constructed based on the selected training sequence.
